(19) United States
(12) Patent Application Publication
(10) Pub. No.: US 2007/0246416 A1
(43) Pub. Date: Oct. 25, 2007

(54) Apparatus for magnetically treating fluid

(76) Inventors: Gregory A. Harcourt, Flinton (CA); Roger M. Pemberton, Toronto (CA)

Correspondence Address: TORYS LLP, 79 WELLINGTON ST. WEST, SUITE 3000, TORONTO, ON, M5K 1N2, CA

(21) Appl. No.: 11/334,723

(22) Filed: Jan. 19, 2006

(51) Int. Cl. C02F 1/48

(52) U.S. Cl. 210/222

(57) ABSTRACT

An apparatus for magnetically treating fluid in a fluid conduit includes one or more magnets adapted for placement adjacent a fluid conduit in such a manner as to allow the magnet(s) to subject fluid flowing within the conduit to magnetic field(s) produced by the magnet(s). The magnets are enclosed by inner and outer shields of, respectively, non-ferrous and ferrous composition. In some embodiments apparatus according to the invention further comprise coils having pluralities of contiguous non-overlapping turns axially enclosing the magnet(s) and the fluid conduits adjacent to which the magnet(s) are disposed. Apparatus according to the invention may advantageously be employed in pluralities connected in series and/or parallel relationships.

### FIELD OF THE INVENTION

The present invention relates generally to method and apparatus for magnetically treating fluids.

### BACKGROUND

Magnetic fluid conditioning, sometimes referred to as Magneto Hydro Dynamics (MHD), has been studied throughout the world, and in particular the former U.S.S.R., as a way to prevent loosen or remove scale or crust from water pipes, boilers, heat exchangers and the like. MHD has also been suggested as a way to improve fuel efficiency of internal combustion engines, to improve efficiency of refrigeration systems, improve water softening systems and reduce detergent requirements in laundry operations, and even to reduce biological encrustations or tissue growth in water pipes.

Numerous magnetic devices have been developed and attention is drawn to U.S. Pat. Nos. 2,652,535; 3,228,878; 4,146,479 among others.

### SUMMARY

The invention provides improved systems and apparatus for the magnetic treatment of fluids flowing in conduits.

According to an aspect of the invention there is provided an apparatus for magnetically treating fluid in a fluid conduit. The apparatus includes one or more magnets adapted for placement adjacent a fluid conduit in such a manner as to allow the magnet(s) to subject fluid flowing within the conduit to magnetic field(s) produced by the magnet(s). The apparatus also comprises inner and outer shields for containing and focusing the magnetic field(s) produced by the magnet(s). Any one or more of the magnet(s), inner shield, and outer shield may be connected to ground.

The invention may further include a housing to contain and support the magnet(s). The housing may for example be adapted for receiving the fluid conduit and, in order to facilitate supporting the magnet adjacent the fluid conduit without harmful or destructive modification of the fluid conduit, may be provided in a plurality of parts, the plurality of parts being joinable to form the housing. The housing may be formed from or otherwise comprise the inner and outer shields.

The inner and outer shields may comprise a ferrous outer shield and a non-ferrous inner shield, either or both of which may be connected to ground. A non-conductive insulator may be disposed between the inner shield and the outer shields to prevent corrosion and other undesirable effects.

The apparatus may further comprise a coil having a plurality of contiguous non-overlapping turns axially enclosing the fluid conduit and the magnet(s). The coil may include two ends, either or both of which may be connected to the ground. One or more diodes may be provided in one or more turns of the coil, the diodes being in a series relationship to each other.

### BRIEF DESCRIPTION OF THE DRAWINGS

The invention will now be described by way of example only, and with reference to the accompanying drawings, in which like numbers refer to like part.

FIG. 1 is an isometric view of an apparatus for magnetically treating fluids in accordance with the invention.

FIG. 2 is a cut-away schematic side view of the apparatus of FIG. 1.

FIG. 3 is an isometric view of an apparatus for magnetically treating fluids in accordance with the invention.

FIG. 4 is a cross section of the apparatus of FIG. 3, viewed along lines 2-2.

FIG. 5 is an isometric view of the apparatus of FIG. 3 separated into parts.

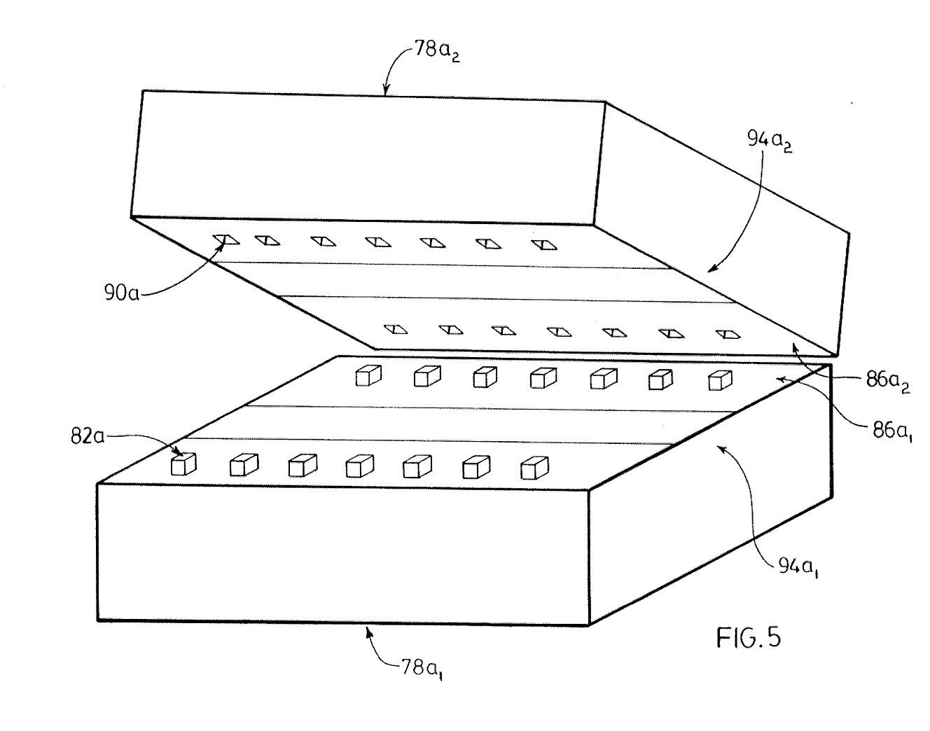

FIG. 6 is a schematic diagram of system for magnetically treating fluid in a thermal siphon circulation.

FIG. 7 is a schematic diagram of system for magnetically treating fluid in a laundry.

FIG. 8 is an isometric view of an apparatus for magnetically treating fluids in accordance with the invention, in an uninstalled condition.

FIG. 9 is a cross-sectional schematic view of the apparatus of FIG. 8, in an installed condition.

### DETAILED DESCRIPTION

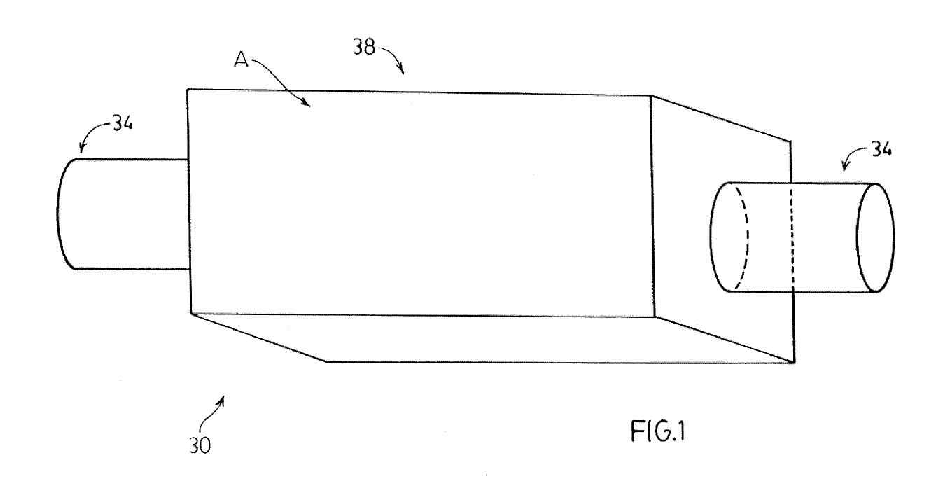

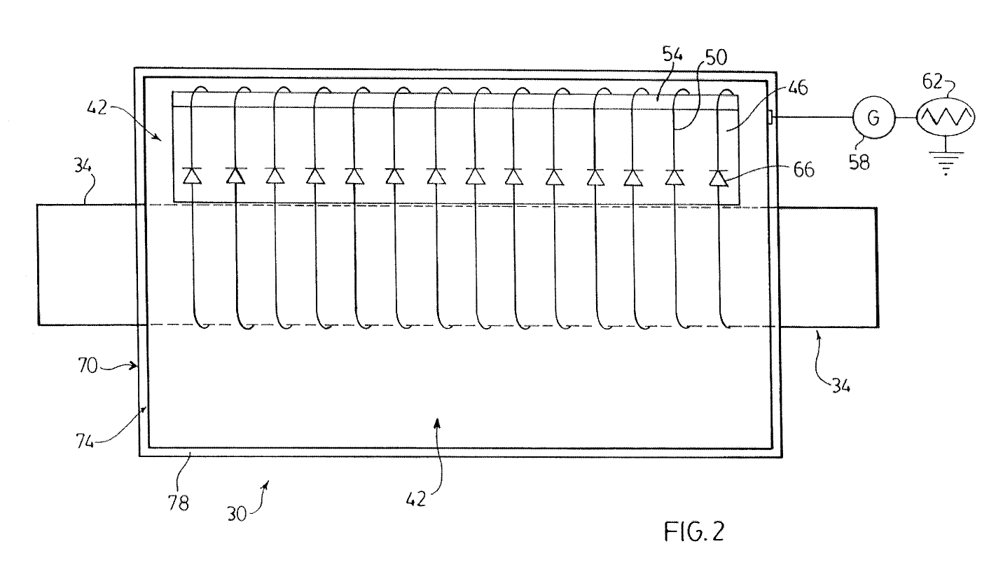

Referring to FIGS. 1 and 2, an apparatus for magnetically treating a fluid in accordance with an embodiment of the invention is indicated generally at 30. Apparatus 30 comprises at least one magnet 46, inner shield 74, and outer shield 70 adjacent fluid conduit 34. Magnet 46 is disposed adjacent fluid conduit 34 in such a manner as to expose fluid flowing within conduit 34 to a magnetic field produced by magnet 46. In the embodiment shown, apparatus 30 further includes a housing 38 for supporting magnet 46, inner shield 74, and outer shield 70 adjacent to fluid conduit 34. Also shown in the illustrated embodiment is non-conductive insulator 78, disposed between inner shield 74 and outer shield 70 to prevent corrosion and other undesirable effects, and coil 50 comprising a plurality of contiguous non-overlapping turns axially enclosing the fluid conduit 34 and magnet 46. Coil 50 also includes diodes 66 which are disposed in each turn of coil 50 and are connected in series relationship.

Magnet 46 can comprise any number of permanent or temporary magnets such as electromagnets. As will be understood by those skilled in the relevant arts, the selection of magnets suitable for use in implementing the invention will be based at least in part on the strength of the magnetic field desired to be induced within conduit 34, which field strength will depend, among other factors, on the size, strength, and composition of the magnet, its proximity to conduit 34, the size and composition of conduit 34, and the characteristics of the fluid to be treated, including its anticipated flow rate. The selection of magnets of suitable composition and strength to apply fields of desired strength within given locations is well understood; the selection of magnets suitable for use in implementing the invention will be well within the ability of those of ordinary skill in the art once they have been made familiar with this disclosure. A wide variety of magnets suitable for use in implementing the invention in the context of a typical building or home water supply are now available commercially from a number of suppliers, including for example Master Magnetic Inc., of Castle Rock, Colo.

As shown in FIG. 2, inner shield 74 is disposed adjacent to and substantially encloses magnet 46 and fluid conduit 34, in order to focus and contain, as by reflection, the magnetic field generated by magnet 46 in order to concentrate the magnetic flux within conduit 34, so that fluid flowing within the conduit is subjected to a magnetic field of maximum possible strength. Inner shield 74 is preferably composed of non-ferrous metals such as aluminium, copper, bronze, or brass. The inventors have achieved particularly satisfactory results by using aluminium to compose inner shield 74. It has also been observed that the effectiveness of inner shield 74, and of apparatus 30, can be improved by connecting inner shield 74 to an electrical ground.

As will be understood by those skilled in the relevant arts, the configuration of inner shield 74, including its size, shape, and thickness, may be varied in order to achieve a desired concentration of magnetic flux within the desired region inside conduit 34. The inventors have observed for example that an inner shield composed of aluminium and substantially enclosing magnet(s) 46, as well as adjacent portions of conduit 34 (i.e., by providing at least about 80% enclosure, exclusive of the conduit), of between 0.03 and 0.2 inch gage, provides satisfactory results in commercial laundry installation in an apparatus installed on a 2½ ferrous water pipe.

Criteria used for determining the appropriate composition and configuration of inner shield 74 can include, among other factors, the strength of magnet(s) 46, the composition, shape and size of fluid conduit 34, as well as the type and flow rate of the fluid carried by conduit 34.

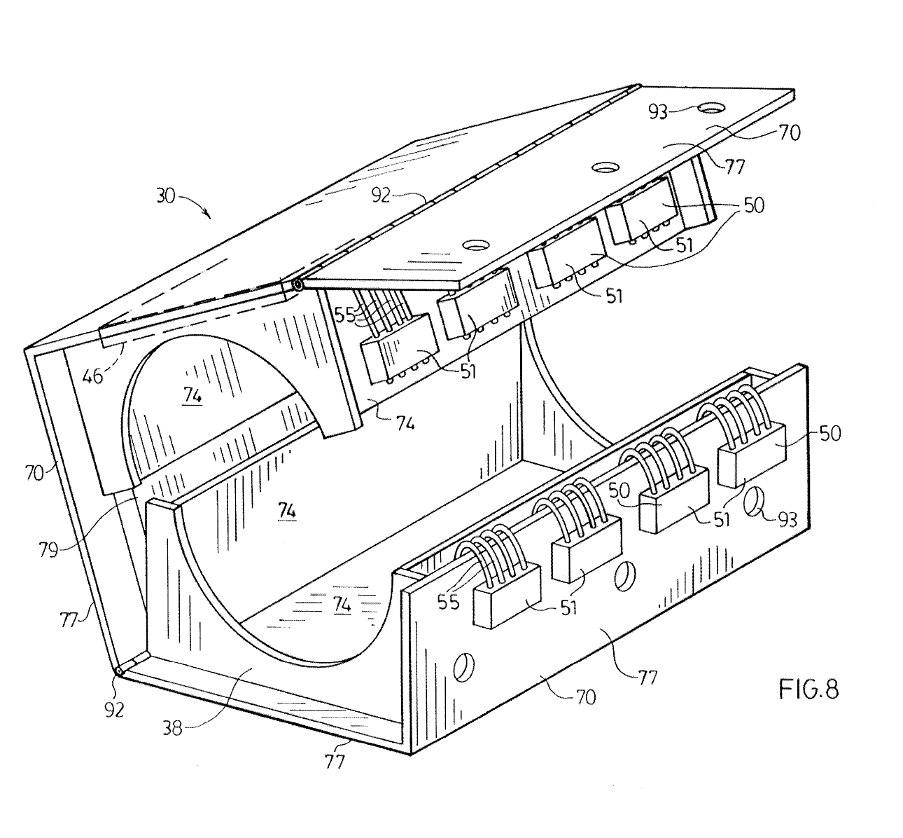

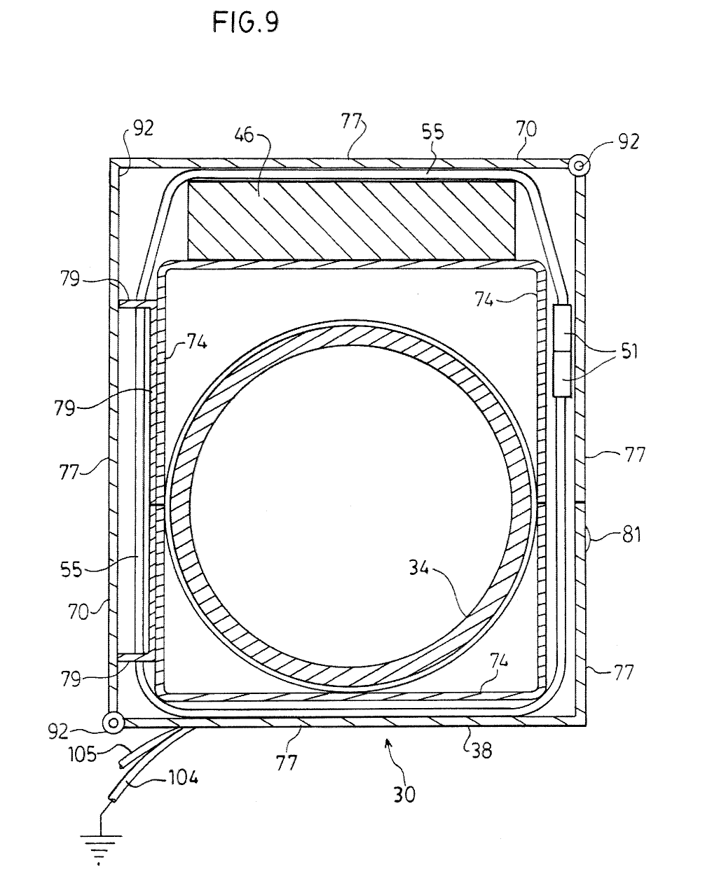

Outer shield 70 is disposed adjacent to and substantially encloses inner shield 74, thereby further containing the magnetic field inside the enclosure and due to its ferrous composition developing a residual, complementary magnetic field of its own. Accordingly, inner shield 74 and outer shield 70 operate in combination to increase the effectiveness of the magnetic fields within, improving the quality of magnetic conditioning provided by apparatus 30. Outer shield 70 is preferably composed of ferrous material, including for example steel. The inventors have achieved particularly satisfactory results by using stainless steel to compose outer shield 70. Among other advantages, such as those noted herein, the use of stainless steel provides for a durable and robust construction resistant to the wear and tear of installation and use. Such durability is particularly useful in embodiments of the invention in which the apparatus is removable and re-usable, such as that shown in FIGS. 8 and 9. It has also been observed that the effectiveness of outer shield 70, and of apparatus 30, can be improved by connecting outer shield 70 to an electrical ground.

As will be understood by those skilled in the relevant arts, the configuration of outer shield 70, including its size, shape, and thickness, may be varied in order to achieve a desired concentration of magnetic flux within the desired region inside conduit 34. The inventors have observed for example that an outer shield 70 composed of stainless steel and substantially enclosing magnet(s) 46 and an aluminium inner shield 74, as well as adjacent portions of conduit 34 (i.e., by providing at least about 80% enclosure, exclusive of the conduit), of between 0.03 and 0.2 inch gage, provides satisfactory results in commercial laundry installation.

Criteria used for determining the appropriate composition and configuration of outer shield 70 can include, among other factors, the strength of magnet(s) 46, the composition, shape and size of fluid conduit 34 and of inner shield 74, as well as the type and flow rate of the fluid carried by conduit 34.

Insulator 78, which may be advantageously disposed between the two shields, can be used for example to prevent corrosion problems and other negative effects that may result from juxtaposing two different materials that make up inner shield 74 and outer shield 70. Insulator 78 may be electrically non-conductive and can be constructed from materials such as rubber or plastic. Thickness of insulator 78 can vary according to the types of materials used in inner and outer shields.

In the illustrated embodiment, apparatus 30 is directed to the treatment of a fluid that passes through fluid conduit 34. It is to be understood that apparatus 30 can be directed to any fluid that can be carried in a variety of conduits, including liquids and gasses in pipes, ducts, channels, and other open and closed conduits. Moreover, fluid conduit 34 may be composed of any of a wide variety of compositions, chosen for example for their magnetic, corrosion-resistant, durability, strength, and fluid-carrying properties. Fluid conduit 34 can for example be constructed from conductive materials such as iron pipes or non-conductive materials such as PVC pipes. The size and diameter of fluid conduit 34 can also vary based on the amount and composition of fluid to be transported.

Apparatus 30 may include a housing 38 adapted for receiving fluid conduit 34. When provided, housing 38 can be configured to carry or otherwise support magnet(s) 46, shields 70, 74 and other features, including for example coil 50. As shown in FIG. 2, it may be advantageous to use one or more of magnet(s) 46 and/or shields 70, 74, to form all or part of a housing 38. In the illustrated embodiment, housing 38 is provided in the form of a rectangular block which surrounds a portion of fluid conduit 34 while supporting components 46, 70, 74, 50 of apparatus 30. However, it is to be understood that in other embodiments, housing 38 can be formed in other shapes that permit the enclosure of a portion of a fluid-carrying conduit, and allow forming an encased cavity around that portion of the conduit for supporting the various features to be included therein.

Housing 38 may be made of any suitable material or combination of materials consistent with the purposes described herein. For example, one or more of magnet(s) 46 and shields 70, 74 can be formed as integral or integrated parts of the housing 38; or they may merely be structurally supported by the housing, as for example through the provision of suitable molded or attached support elements. Portions of the housing 38 not intended to act as shields 70, 74 can be composed of, for example, PVC, nylon, or other plastics or polymers, woods, or other conductive or non-conductive materials.

A wide variety of construction techniques may be employed in providing housings 38, where provided. For example, one or more exterior and support portions of the housing may be made of injection molded plastic, configured to accept the various components 46, 70, 74, 50, with any remaining voids filled with further plastics, foams, or other materials.

Housing 38 may comprise or otherwise support one or more coils 50 useful for example for strengthening or otherwise controlling the magnetic field generated by magnet 46. For example, in the embodiment shown, coil 50 is formed by a series of non-overlapping contiguous turns that surround magnet 46, a collector plate 54 and fluid conduit 34. As will be understood by those skilled in the relevant arts, coil 50 can be wound clockwise or anti-clock wise. Either or both ends of coil 50 may be connected to ground. In the embodiment shown, one end of coil 50 is connected to ground directly, while the other end is connected to a current generator 58 and resistor 62. Also provided is one or more diode 66 in each of a plurality of turns of coil 50. For example, one or more diodes may be provided in each turn, in every second, third, or forth turn, or so on. As will be apparent to those skilled in the relevant arts, the effectiveness of the diodes in enhancing the fluid-treating properties of apparatus 30 will vary in accordance with the electrical characteristics of the diodes, and the number of turns on which they are applied. Coil 50 is operable to strengthen the magnetic flux applied to the fluid passing through Coil 50, improving the effectiveness of magnetic treatment.

Coil 50 may be disposed within and therefore substantially enclosed by either or both of inner and/or outer shields 70, 74. Optional plate 54, which may for example be disposed adjacent magnet(s) 46 within inner shield 74 and coil 50, can function as a backup or collector of the magnetic field [NOTE TO DRAFT: correct?] to improve the efficiency of apparatus 30 and is preferably made of a ferrous material such as steel.

It can be advantageous in some applications to configure one or more of magnet(s) 46, housing 38, and shields 70, 74 so as to expose fluid flowing within conduit 34 to only one pole or set of poles (i.e., north or south) of magnet(s) 46. For example, it has been observed that pH levels of water and other fluids may be affected by selective exposure of fluid flows to one or the other of the magnetic poles. Controlling the pH levels of fluids can be useful, for example, in controlling calcium (limestone) scale build-up in conduits and the absorption by fluids of various materials, such as laundry detergents.

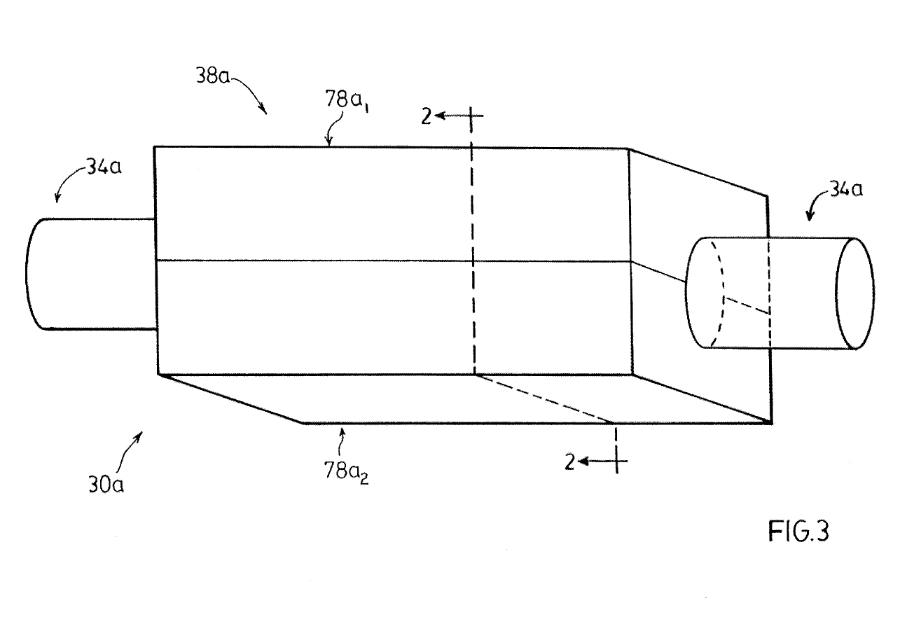

In the embodiment shown in FIGS. 1 and 2, housing 38 is formed as a single, integral unit. In many applications, however, it can be advantageous to form housing 38 in a multi-part configuration, so as for example to facilitate non-destructive installation and removal of the apparatus on a fluid conduit 34. For example, FIG. 3 depicts an apparatus 30a comprising a housing 38a configured in the form of two component units. Apparatus 30a is in many respects similar to apparatus 30, and like elements in apparatus 30a bear the same reference as like elements in apparatus 30, except followed by the suffix “a”.

In the embodiments shown, apparatus 30a of FIG. 3 differs from apparatus 30 of FIGS. 1 and 2 in that apparatus 30a includes a housing 38a comprised of two parts, part 78a₁ and 78a₂, which include a number of conductive cables 100a adapted for providing electrical continuity within coil 50a when the two component parts 78a₁ and 78a₂ are aligned as for installation.

Various mechanisms for joining multiple components of a housing 38a may be used. Such mechanisms include, for example, screwing, riveting, clamping, gluing, and interference or friction fit between parts. Moreover, depending on the joining mechanism used, the assembly of the housing may be reversible, allowing for non-destructive disassembly of the apparatus.

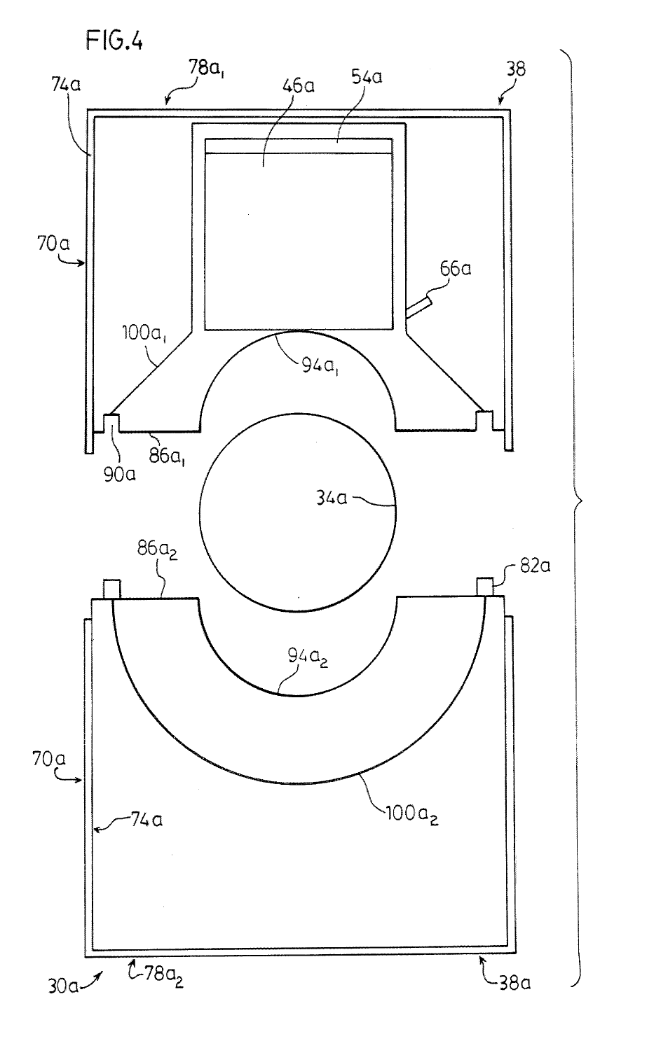

FIG. 4 shows a cross-section of apparatus 30a viewed along lines 2-2 of FIG. 3. In the illustrated embodiment, a joining mechanism for housing 38a is provided in the form of male contacts 82a and receptors 90a. Receptors 90a correspond in number and location to contacts 82a, such that when part 78a₁ is aligned with part 78a₂, contacts 82a can engage receptors 90a to assemble housing 38a while maintaining electrical continuity in conductive cables 100a of coil 50a. Specifically, in the illustrated example, cables 100a form parts of respective turns around magnet 46a and/or fluid conduit 34a.

A housing 38 and in particular a multi-part housing 38a may further include removable inserts to, for example, accommodate installation of the housing 38, 38a for conduits of various sizes and configurations. As shown in FIG. 4, for example, the two parts 78a₁, 78a₂, of housing 38a each include an insert 86a configured by means of an axially elongated saddle geometry to abut fluid conduit 34a when installed, allowing apparatus 30a to fit with a desired degree of proximity around fluid conduit 34a. By altering the diameter and the shape of saddle 94a, housing 38a can be adapted to fit conduits of various sizes and shapes according to various tolerances.

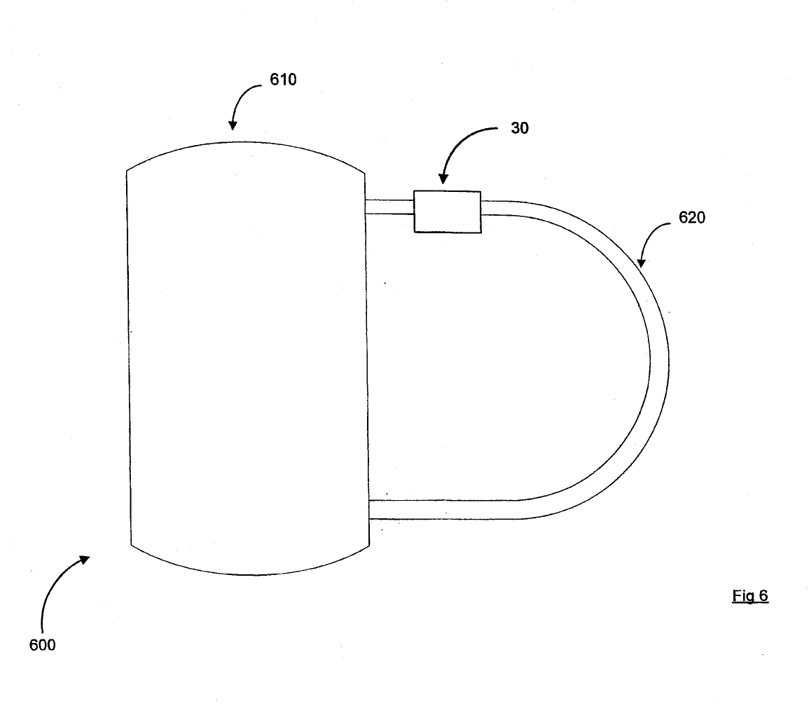

Apparatus 30, 30a and other embodiments of the invention can be used in a variety of systems for magnetically treating water and other fluids, for a variety of applications. For example, referring to FIG. 6, a system for magnetically treating fluid in a thermal siphon circulation is indicated generally at 600. System 600 includes a water storage tank 610 for storing a hot fluid such as water, siphon conduit 620 for establishing a thermal siphon circulation, and apparatus 30 according to the invention. The use of apparatus 30 in a thermal siphon system offers numerous advantages such as may be obtained by continuously magnetically treating fluid stored in the tank 610 as it circulates, as for example as a result of thermal convection, through conduit 620. It has been found, for example, that installation of an apparatus 30 according to the invention on a siphon conduit 620 of a water heater system 600 can provide for continuous treatment of water circulating through the conduit, resulting in significant reductions in scale build-up within tank 610, conduit 620, and attached fluid circuits.

Thermal siphon systems are commonly provided in water heating systems, solar panel installations, and in other heating/cooling systems.

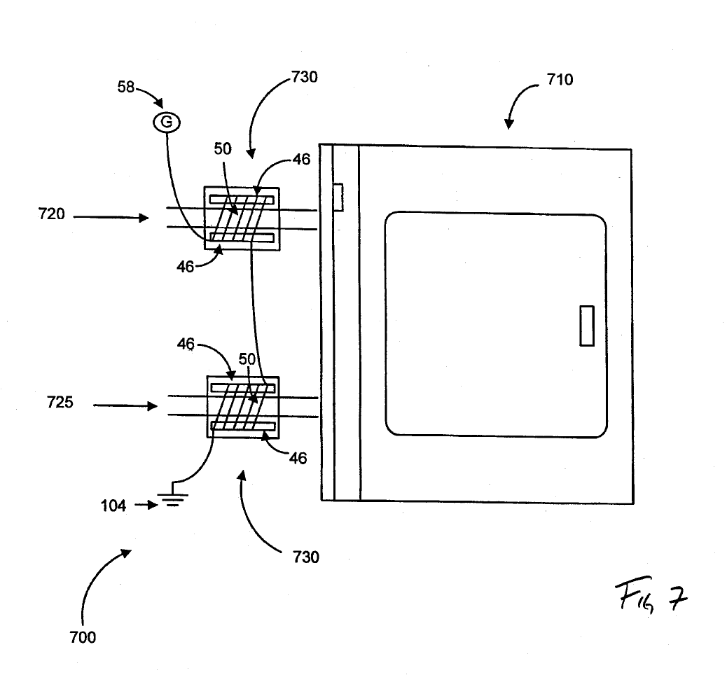

FIG. 7 depicts another example application for apparatus in accordance with the invention. Specifically, a system for magnetically treating water in a laundry is indicated generally at 700. System 700 includes a washing machine 710, a hot water inlet conduit 720, and a cold water inlet conduit 725. Each of inlets 720, 725 comprises an apparatus 30 according to the invention. It has been observed, as previously noted, that the use of one or more apparatuses 30 in laundry systems provides a number of benefits, including for example increased efficiency in the absorption and use of detergents.

It has been particularly beneficial, for example, to provide a plurality of apparatuses 30 according to the invention in fluid systems comprising more than one fluid transfer line (such as a water inlet or outlet), and to connect such apparatuses 30 in series and/or parallel relationship. For example, as shown in FIG. 7, apparatuses 30 each comprise a plurality of magnets 46 and a coil 50, the windings of which are connected in a series relationship and at one ended connected to ground 104. The connection of apparatuses 30 in series and/or parallel relationships has been observed to provide a more satisfactory treatment of fluids in the affected conduits, both where a single fluid line is treated multiple times by multiple apparatuses 30, and where parallel fluid lines are treated, as shown for example in FIG. 7.

It has further been observed that the efficiency of apparatuses 30 can be enhanced by applying to coil(s) 50 and/or to one or more of magnets 46 a variable current generated by, for example, a variable current generator 58.

In variations of apparatus 30 or 30a, the specifics of the electrical circuitry used for coil 50 or 50a can also vary. For example, in one variation, no current generator can be used, and both ends of coil 50, or 50a can be grounded directly. In other variations, diodes 66 or 66a, ferrous plate 54 or 54a, resistors 62 or 62a, and/or other components can be omitted.

FIG. 8 is an isometric view of another embodiment of an apparatus 30 for magnetically treating fluids in accordance with the invention, in an uninstalled condition. FIG. 9 is a cross-sectional schematic view of the apparatus of FIG. 8, installed on a pipe or other conduit 34. In the embodiment shown in FIG. 8, housing 38 is composed substantially of outer shield 70, which is formed of a plurality of ferrous plates 77, fabricated of for example stainless steel, connected by hinges 92. As may be seen, through the use of hinges 92 and attachments such as for example bolts or screws 81 cooperating with optionally-threaded attachment holes 93, apparatus 30 is removably installable on a pipe or other conduit 34.

In the embodiment shown in FIGS. 8 and 9 inner housing 74 is comprised of a pair of formed sheet metal plates, fabricated using for example aluminium brazed, adhered, or otherwise attached to one or more of plates 77. Coil 50 comprises a number of wire segments 55 attached to releasable connectors 51. Wire segments 55 are protected in moving portions of apparatus 30 by an optionally-removable plate 79.

The above-described embodiments of the invention are intended to be examples of the present invention and alterations and modifications may be effected thereto, by those of skill in the art, without departing from the scope of the invention which is defined solely by the claims appended hereto. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

What is claimed is:

1. Apparatus for magnetically treating a fluid in a fluid conduit, the apparatus comprising:
at least one magnet adapted for placement adjacent a fluid conduit;
a housing containing the at least one magnet; the housing adapted for receiving the fluid conduit; the housing having at least two parts; the at least two parts joinable to form the housing;
the housing comprising a ferrous outer shield and a non-ferrous inner shield; at least one of the inner shield and the outer shield comprising a connection to ground;
a non-conductive insulator disposed between the inner shield and the outer shield;
a coil having a plurality of contiguous non-overlapping turns axially enclosing the fluid conduit and the at least one magnet; the coil having two ends; the coil being disposed in said housing; at least one end comprising a connection to the ground; and
at least one diode in each of a plurality of said turns of the coil, the diodes being in a series relationship to each other.

2. Apparatus for magnetically treating a fluid in a fluid conduit, the apparatus comprising a housing containing at least one magnet, a ferrous outer shield, and a non-ferrous inner shield; the housing adapted for supporting the at least one magnet adjacent the fluid conduit.

3. The apparatus of claim 2, wherein the housing is adapted for receiving the fluid conduit.

4. The apparatus of claim 2, wherein the housing comprises at least two parts; the at least two parts joinable to form the housing.

5. The apparatus of claim 2 wherein the housing forms a saddle for externally abutting against the portion of the fluid conduit adjacent the at least one magnetic device.

6. The apparatus of claim 2, further comprising a non-conductive insulator disposed between the inner shield and the outer shield.

7. The apparatus of claim 2, wherein the outer shield is composed of steel.

8. The apparatus of claim 2, wherein the inner shield is composed of aluminum.

9. The apparatus of claim 2, further comprising a variable-voltage power source adapted for providing a variable current flow through the at least one magnet.

10. The apparatus of claim 3 further comprising:
a coil disposed within the housing and having a plurality of contiguous non-overlapping turns axially enclosing the fluid conduit and the at least one magnet; the coil having two ends, at least one end comprising a connection to a ground; and
at least one diode in each of a plurality of said turns of the coil, the diodes being in a series relationship to each other.

11. The apparatus of claim 2, wherein at least one of the inner shield and the outer shield comprises a connection to ground.

12. A system for magnetically treating fluid in a thermal siphon circulation, the system comprising:
a siphon conduit connected to a fluid storage tank;
a housing containing at least one magnet, a ferrous outer shield, and a non-ferrous inner shield; the housing adapted for supporting the at least one magnet adjacent the siphon conduit.

13. A system for magnetically treating fluid in a laundry, the system comprising:
a first apparatus, comprising a first housing containing at least one magnet, a ferrous outer shield, and a non-ferrous inner shield; the first housing adapted for supporting the at least one magnet adjacent a cold water inlet conduit; and
a second apparatus, comprising a second housing containing at least one other magnet, a ferrous outer shield, and a non-ferrous inner shield; the second housing adapted for supporting the at least one magnet adjacent a hot water inlet conduit.

14. A system for magnetically treating a fluid in a fluid conduit; the system comprising:
a first apparatus, the first apparatus comprising a first housing containing at least one magnet, a ferrous outer shield, a non-ferrous inner shield, and a first coil, the first coil comprising a plurality of contiguous non-overlapping turns axially enclosing the at least one magnet and a first portion of the fluid conduit, the first coil further comprising a first end and a second end, the first end. connected to ground;
a second apparatus, the second apparatus comprising a second housing containing at least one other magnet, a ferrous outer shield, a non-ferrous inner shield, and a second coil, the second coil comprising a plurality of contiguous non-overlapping turns axially enclosing the at least one magnet and a second portion of the fluid conduit, the second coil further comprising a first end and a second end, the first end connected to ground; and
a connection for connecting said second end of said first coil and said second end of said second coil.

15. Apparatus for magnetically treating a fluid along a fluid conduit, the apparatus comprising:
at least one magnet for applying a magnetic field to a fluid; the at least one magnet adapted for placement adjacent a portion of the fluid conduit; and
a housing having an outer wall for containing said magnet and said magnetic field; the housing adapted for receiving the fluid conduit; the outer wall comprising a ferrous outer shield and a non-ferrous inner shield.

16. Apparatus for magnetically treating a fluid flow within a fluid conduit, the apparatus comprising:
at least one magnet adapted for placement adjacent a fluid flow path;
a non-ferrous inner shield substantially enclosing the at least one magnet and at least a portion of the fluid flow path adjacent the at least one magnet; and
a ferrous outer shield substantially enclosing the inner shield.

17. The apparatus of claim 16, further comprising a non-conductive insulator disposed between the inner shield and the outer shield.

18. The apparatus of claim 16, wherein the outer shield is composed of steel.

19. The apparatus of claim 16, wherein the inner shield is composed of aluminum.

20. The apparatus of claim 16, further comprising a variable-voltage power source adapted for variable current flow through the at least one magnet.

21. The apparatus of claim 16, wherein at least one of the inner shield and the outer shield comprises a connection to the ground.
